(19) United States
(12) Patent Application Publication
(10) Pub. No.: US 2007/0207687 A1
(43) Pub. Date: Sep. 6, 2007

(54) Method for producing artificial leather

(75) Inventors: Ching-Tang Wang, Taipei (TW); Mong-Ching Lin, Yancheng Chiu (TW); Chung-Chih Feng, Samin Chin (TW); Jung-Ching Chang, Tzuooyng Chiu (TW); Hsien-Chang Hung, Tzuooyng Chiu (TW); Ping-Liang Chiu, Neypuu Shiang (TW); Chien-Te Wu, Wanndan Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co., LTD., Kaohsiung (TW)

(21) Appl. No.: 11/712,549

(22) Filed: Feb. 28, 2007

Related U.S. Application Data
(63) Continuation-in-part of application No. 10/838,728, filed on May 3, 2004, now abandoned.

(51) Int. Cl. B32B 5/02; B32B 27/04; B32B 27/02

(52) U.S. Cl. 442/59; 442/164; 442/64

(57) ABSTRACT

Artificial leather includes a substrate and a coating of a first elastomeric resin provided on the substrate. The substrate contains a second elastomeric resin evenly spread in the substrate. The first elastomeric resin forming the coating is identical to the second elastomeric resin in the substrate. The substrate includes a first porous structure. The coating includes a second porous structure contiguous to the first porous structure of the substrate. Preferably, the substrate has a density larger than that of the coating.

### CROSS REFERENCE TO RELATED APPLICATION

This is a continuation-in-part application of U.S. patent application Ser. No. 10/838,728 filed May 3, 2004.

### FIELD OF INVENTION

The present invention relates to artificial leather.

### BACKGROUND OF INVENTION

Artificial leather includes a layer of cloth (“substrate”) and a layer of elastomeric resin (“coating”) formed on the substrate. Generally, the substrate is a layer of non-woven cloth. To provide an integral look, the substrate must be dyed and the hue of the substrate must be identical to that of the coating.

To this end, two processes have been taken for production of artificial leather. In the first process, the substrate is submerged in a first type of elastomeric resin of a color so that the substrate is dyed. Then, in a pre-coagulating step, the first type of elastomeric resin absorbed by the substrate coagulates. After the pre-coagulating step, the substrate is coated with a second type of elastomeric resin. Compared with the first type of elastomeric resin, the second type of elastomeric resin includes a high solid content. The second type of elastomeric resin is of the same color as the first type of elastomeric resin. Then, the coating coagulates.

After that, the artificial leather is washed and dried. The second process is identical to the first process except for saving the pre-coagulating step. In other words, the substrate is coated with the second type of elastomeric resin when the substrate is still wet from the first type of elastomeric resin.

FIGS. 1 and 1A show artificial leather 100 made according to the first process. The artificial leather 100 includes a substrate 102, a coating 104 of the second type of elastomeric resin and particles 106 of the first type of elastomeric resin filled in the substrate 102. Because of the pre-coagulating step, the particles 106 of the first type of elastomeric resin are evenly scattered in the substrate 102 on one hand. On the other hand, moisture exists on the surface of the substrate 102. The moisture dissolves an amount of the second type of elastomeric resin when the substrate 102 is coated with the second type of elastomeric resin. This amount of the second type of elastomeric resin dissolved in the moisture eventually forms a dense layer 108 (see the boundary section 109). The dense layer 108 provides an undesirable laminate look to the artificial leather 100. Furthermore, the boundary section 109 isolates the porous structure of the substrate 102 from the porous structure of the coating 104, leading to poor air permeability. Furthermore, a dyeing process is required to make the coating 104 and the substrate 102 have the same color. Furthermore, the laminate structure of the artificial leather 100 results in poor peel strength; namely, the coating 104 and the substrate 102 are liable to peel off from each other. Furthermore, the coating 104 has a density larger than that of the substrate 102 such that the artificial leather is liable to warp. Specifically, when the artificial leather shown in FIGS. 2 and 2A is placed on a table in a flattened state, two edges of the artificial leather warp upward and toward each other. The warping is more serious for a small piece of artificial leather.

FIGS. 2 and 2A show artificial leather 200 made according to the second process. The artificial leather 200 includes a substrate 202, a coating 204, and particles of a first type of elastomeric resin 208. The substrate 202 is submerged in the first type of elastomeric resin. The first type of elastomeric resin will eventually coagulate and become the particles 208. Before the first type of elastomeric resin coagulates, the substrate 202 is coated with the second type of elastomeric resin. The second type of elastomeric resin will eventually coagulate and become the coating 204. Without undertaking the pre-coagulating step, no dense layer occurs in the artificial leather 200. However, when coated with the second type of elastomeric resin, the substrate 202 absorbs an amount of the second type of elastomeric resin. This amount of the second type of elastomeric resin reaches an area near the interface between the substrate 202 and the coating 204. In this area of the substrate 202, the second type of elastomeric resin coagulates and becomes particles 206. The uneven presence is not desirable. Furthermore, the particles 206 forms a boundary section 209 that isolates the porous structure of the substrate 202 from the porous structure of the coating 204, leading to poor air permeability. Furthermore, a dyeing process is required to make the coating 204 and the substrate 202 have the same color. Furthermore, the laminate structure of the artificial leather 200 results in poor peel strength. Furthermore, the coating 204 has a density larger than that of the substrate 202 such that the artificial leather is liable to warp. Specifically, when the artificial leather shown in FIGS. 3 and 3A is placed on a table in a flattened state, two edges of the artificial leather warp upward and toward each other. The warping is more serious for a small piece of artificial leather.

It is therefore a need in artificial leather that obviates or at least alleviates the disadvantages encountered in prior art.

### SUMMARY OF INVENTION

The present invention solves this need and other problems in the field of artificial leather by providing artificial leather including a substrate and a coating of a first elastomeric resin provided on the substrate. The substrate contains a second elastomeric resin evenly spread in the substrate. The first elastomeric resin forming the coating is identical to the second elastomeric resin in the substrate. The substrate includes a first porous structure. The coating includes a second porous structure contiguous to the first porous structure of the substrate.

In a preferred embodiment, the substrate is non-woven cloth or woven cloth. The artificial leather has a peel strength of at least 3.2 kg/cm.

The first elastomeric resin is one-component polyurethane, styrene butadiene rubber, nitrile butadiene rubber, polyamide, or acrylic.

The density of the substrate is greater than that of the coating. Preferably, a density ratio of the substrate to the coating is in a range of 1.1 to 1.5. This solves the warping problem of artificial leathers.

Other objects, advantages and novel features of the invention will become more apparent from the following detailed description in conjunction with the attached drawings.

### BRIEF DESCRIPTION OF DRAWINGS

The present invention will be described via detailed illustration of a preferred embodiment referring to the drawings.

FIG. 1 is a cross-sectional view of artificial leather according to the preferred teachings of the present invention.

FIG. 1A is a photograph of the artificial leather according to the present invention obtained by a scanning electron microscope.

FIG. 2 is a cross-sectional view of a first conventional type of artificial leather.

FIG. 2A is a photograph of the artificial leather of FIG. 2 obtained by a scanning electron microscope.

FIG. 3 is a cross-sectional view of a second conventional type of artificial leather.

FIG. 3A is a photograph of the artificial leather of FIG. 3 obtained by a scanning electron microscope.

### DETAILED DESCRIPTION OF EMBODIMENTS

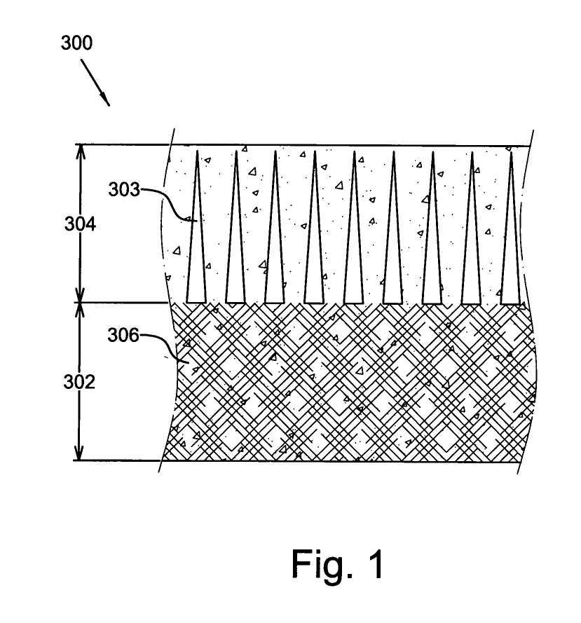

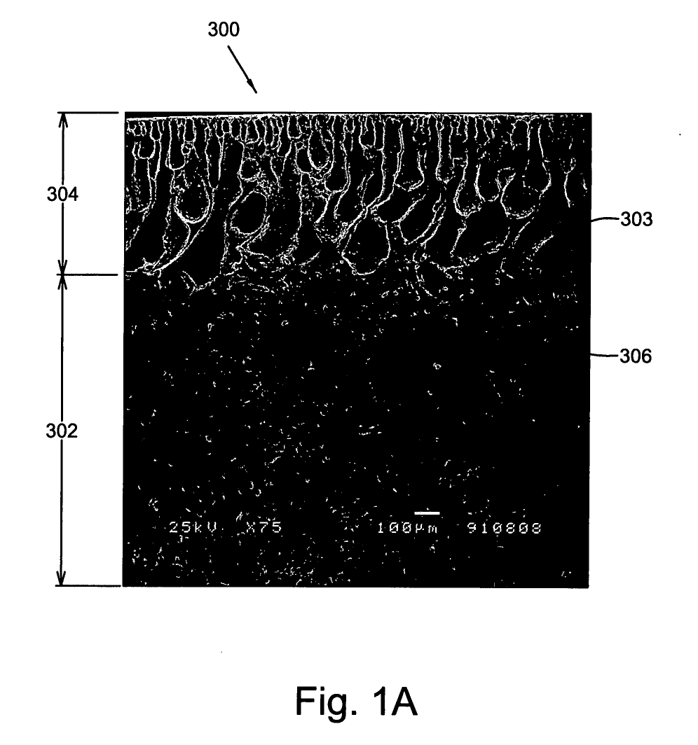

Referring to FIGS. 1 and 1A, artificial leather according to the preferred teachings of the present invention is designated 300 and includes a layer 302 of cloth (“substrate”), a layer 304 of a single type of elastomeric resin (“coating”) and particles 306 of the single type of elastomeric resin scattered evenly in the substrate 302. A method for production of the artificial leather 300 will be described.

Firstly, the substrate 302 is provided. The substrate 302 is preferably non-woven cloth with a thickness of 0.5-2.2 mm and a specific weight of 70-600 μm². The substrate 302 may be submerged in silicone polymer with surface-active agent of anion and water-soluble resin such as water-soluble acrylic and polyvinyl alcohol (“PVA”). Thus, the substrate 302 can better stick to the coating 304. Nevertheless, this submersion step can be omitted so as to be friendly to the environment.

Then, the substrate 302 is coated with the single type of elastomeric resin.

The single type of elastomeric resin is one-component polyurethane, styrene butadiene rubber (“SBR”), nitrile butadiene rubber (“NBR”), polyamide or acrylic. One-component polyurethane is preferred. Now, the single type of elastomeric resin is in the form of liquid so as to permeate the substrate 302 from an upper surface towards a lower surface because of gravity.

However, the gravity alone cannot scatter the single type of elastomeric resin sufficiently and evenly in the substrate 302 particularly when the substrate 302 is thick. Hence, an additional step is taken in order to enhance the infiltration of the single type of elastomeric resin into the substrate 302. Taken properly, the infiltration-enhancing step can ensure that the single type of elastomeric resin evenly permeates into the substrate 302.

The infiltration-enhancing step may be taken via performing vacuum on the lower surface of the substrate 302. Thus, the air pressure on the upper surface of the substrate 302 is less than the air pressure on the lower surface of the substrate 302. Due to the pressure difference between the upper and lower surfaces of the substrate 302, the infiltration rate of the elastomeric resin is increased.

Then, the single of elastomeric resin coated on the substrate 302 coagulates.

Finally, the artificial leather is washed and dried without dyeing processes.

After the artificial leather is washed and dried, the coating 304 may additionally be printed with natural textures through releasing paper or by embossing. Alternatively, the coating 304 may be grinded so as to provide a look imitative of chamois.

The density of the substrate 302 is greater than that of the coating 304. Preferably, a density ratio of the substrate 302 to the coating 304 is in a range of 1.1 to 1.5. Preferably, the density of the substrate 302 is about 0.38-0.45 g/cm³ whereas the density of the coating 304 is about 0.3-0.34 g/cm³.

In a process according to a first embodiment of the present invention, the substrate 302 is woven or non-woven cloth made of polyethylene terephthalate (“PET”), nylon, and other fibers that are mixed at different ratio. Further, the substrate 302 has a thickness of 0.9 mm and a specific weight of 200 g/m². The coating 304 is a layer of PU resin with a solid content of 20%. The coating 304 is 2.2 mm thick. Vacuum is provided on the lower surface of the substrate 302. The vacuum causes a pressure difference of 228 torr between the upper and lower surfaces of the substrate 302. The substrate 302 coated with the single type of elastomeric resin is submerged in a 15:85 mixture of dimethyl foramide (“DMF”) with water for 15 minutes, washed in water of 60 Celsius degrees for 60 minutes and dried in air of 140 Celsius degrees for 20 minutes. The peeling strength of the artificial leather 300 is at least 3.2 kg/cm. The density of the coating 304 is 0.34 g/cm³. The density of the substrate 302 filled with the particles 306 is 0.38 g/cm³. After the artificial leather is washed and dried, the coating 304 may additionally be printed with natural textures through releasing paper or by embossing. Alternatively, the coating 304 may be grinded so as to provide a look imitative of chamois.

In a process according to a second embodiment of the present invention, the substrate 302 includes a thickness of 0.8 mm and a specific weight of 240 g/m². The substrate 302 is submerged in a mixture containing 95% of water, 1% of silicone polymer and 4% of water-dissolvent resin. The coating 304 is a layer of PU resin with a solid content of 20%. The coating 304 is 2.2 mm thick. Vacuum is provided on the lower surface of the substrate 302. The vacuum causes a pressure difference of 300 torr between the upper and lower surfaces of the substrate 302. The substrate 302 coated with the single type of elastomeric resin is submerged in a 15:85 mixture of DMF with water for 15 minutes, washed in water of 60 Celsius degrees for 60 minutes and dried in air of 140 Celsius degrees for 20 minutes. The peeling strength of the artificial leather 300 is at least 3.5 kg/cm. The density of the coating 304 is 0.30 g/cm³. The density of the substrate 302 filled with the particles 306 is 0.45 g/cm³. After the artificial leather is washed and dried, the coating 304 may additionally be printed with natural textures through releasing paper or by embossing. Alternatively, the coating 304 may be grinded so as to provide a look imitative of chamois.

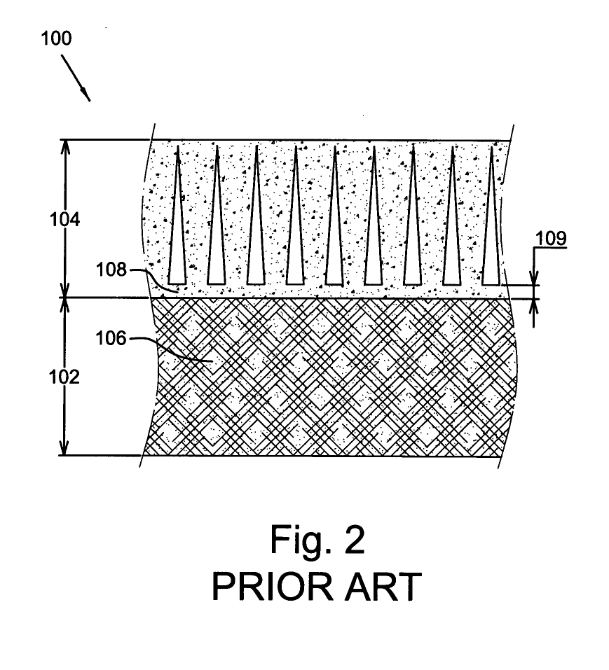

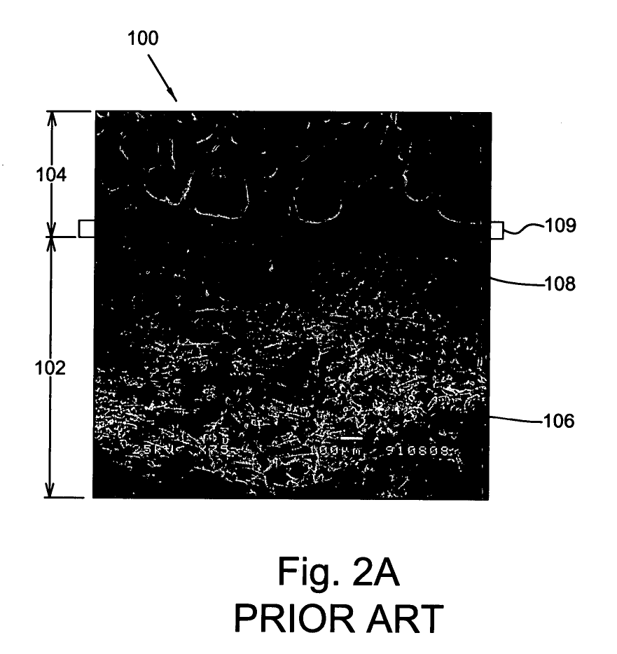

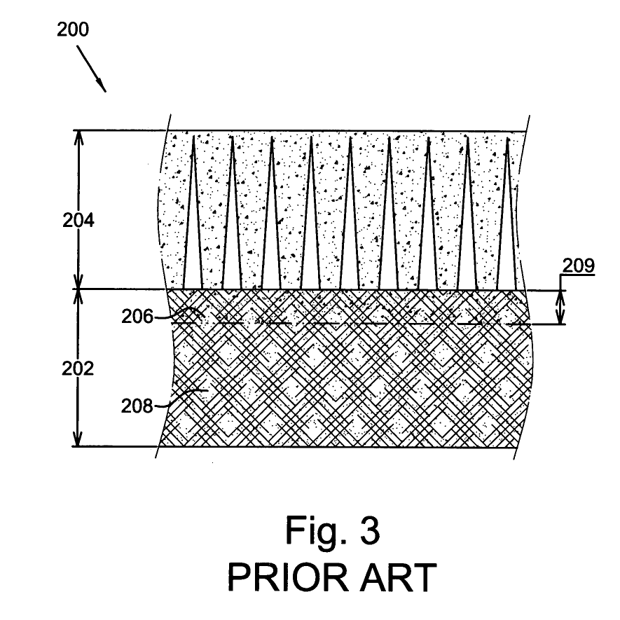

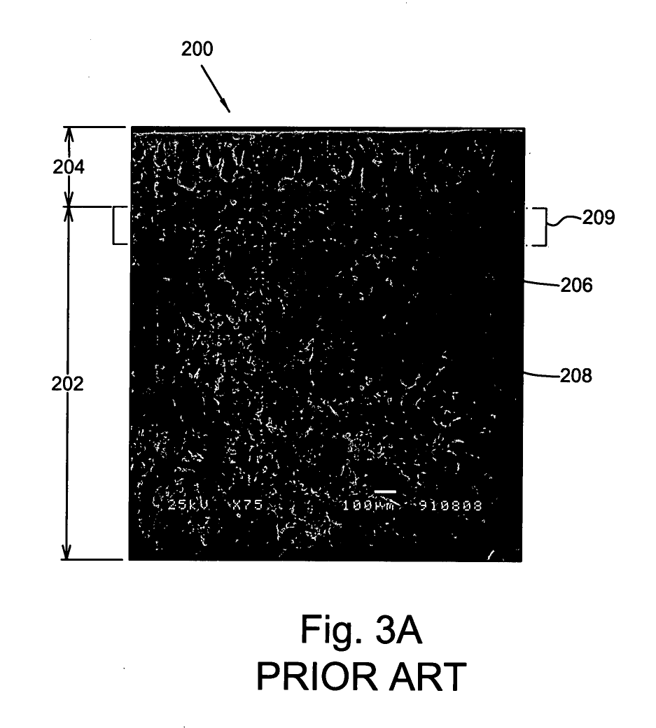

According to the preferred teachings of the present invention, the substrate 302 and the coating 304 of the artificial leather 300 have no boundary line therebetween, as shown in FIG. 1A, whereas the porous structure of the substrate 102 and the porous structure of the coating 104 of the conventional leather shown in FIG. 2A have a boundary section 109 therebetween and the porous structure of the substrate 202 and the porous structure of the coating 204 of the conventional leather shown in FIG. 3A have a boundary section 209 therebetween. An advantage of use of the same type of elastomeric resin in both the substrate 302 and the coating 304 results is that no dyeing process is required, for the substrate 302 and the coating 304 have the same color. Another advantage is that the artificial leather 300 has higher peeling strength, for the substrate 302 and the coating 304 have similar physical properties, and the density ratio therebetween is relatively small compared to conventional artificial leather. Furthermore, submersion of the substrate 302 during the manufacturing of the artificial leather 300 is not necessarily required, which is friendly to the environment. Furthermore, the elastomeric resin spreads evenly in the artificial leather, providing excellent softness. Furthermore, since the same type of elastomeric resin is provided in both the substrate 302 and the coating 304, the porous structure 303 of the substrate 302 is contiguous to the porous structure of the coating 304 (no boundary section is formed) after coagulation of the elastomeric resin, providing excellent air permeability. Furthermore, the substrate 304 has a density larger than that of the coating 302 such that the artificial leather according to the preferred teachings of the present invention is free of the warping problems of conventional artificial leather.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. Artificial leather comprising a substrate and a coating of a first elastomeric resin provided on the substrate, with the substrate containing a second elastomeric resin evenly spread in the substrate, with the first elastomeric resin forming the coating being identical to the second elastomeric resin in the substrate, with the substrate including a first porous structure, and with the coating including a second porous structure contiguous to the first porous structure of the substrate.

2. The artificial leather according to claim 1 wherein the substrate is non-woven cloth or woven cloth.

3. The artificial leather according to claim 1 wherein the artificial leather has a peel strength of at least 3.2 kg/cm.

4. The artificial leather according to claim 1 wherein the first elastomeric resin is one-component polyurethane, styrene butadiene rubber, nitrile butadiene rubber, polyamide, or acrylic.

5. The artificial leather according to claim 1 wherein the substrate has a density larger than that of the coating.

6. The artificial leather according to claim 5 wherein a density ratio of the substrate to the coating is in a range of 1.1 to 1.5.
